(19) United States
(12) Patent Application Publication
(10) Pub. No.: US 2022/0006778 A1
(43) Pub. Date: Jan. 6, 2022

(54) COMPUTING DEVICE AND METHOD FOR GENERATING A FUNCTIONAL IPV6 ADDRESS OF A POD

(71) Applicant: KALOOM INC., MONTREAL (CA)

(72) Inventors: Per ANDERSSON, Montreal (CA); Suresh KRISHNAN, Suwanee, GA (US); Abdallah CHATILA, Verdun (CA)

(73) Assignee: KALOOM INC., MONTREAL (CA)

(21) Appl. No.: 16/919,179

(22) Filed: Jul. 2, 2020

(51) Int. Cl. H04L 29/12; H04L 9/06

(52) U.S. Cl. CPC H04L 61/6059; H04L 9/0643; H04L 61/2007; H04L 61/303

(57) ABSTRACT

Computing device and method for generating a functional IPv6 address of a pod. The computing device stores at least one namespace, at least one associated pod type for each namespace, and an IPv6 base prefix. A namespace is selected among the at least one namespace and a pod type is selected among the at least one pod type associated to the selected namespace. The computing device creates a pod corresponding to the selected namespace and pod type. The computing device generates a pod identifier which uniquely identifies the pod at the computing device level. The computing device generates a namespace field based on the selected namespace and a pod type field based on the selected pod type. The computing device generates a functional IPv6 address of the pod by combining at least the IPv6 base prefix, the namespace field, the pod type field, and the pod identifier.

### TECHNICAL FIELD

The present disclosure relates to large scale multi-device application deployment. More specifically, the present disclosure relates to a computing device and method for generating a functional IPv6 address of a pod.

### BACKGROUND

Kubernetes is an example of a large scale multi-device application deployment framework. In Kubernetes, the application deployment consists in deploying pods. A computing device in Kubernetes is referred to as a node. A pod consists of one or more containers that are co-located on the same node and share resources. Each container executes software and the combination of the software(s) executed by the container(s) of a pod implements an application. One or more pod of the same type can be executed concurrently on the same node, as well as on different nodes.

In Kubernetes, each pod on a node is allocated an Internet Protocol (IP) address for communicating with other entities outside the node, including pods executing on other nodes. The present disclosure focuses on IPv6 addresses.

The usual way of generating an IPv6 address is to combine a topology component and an individual component. For example, the topology component in as IPv6 prefix allocated to the node executing the pod and the individual component is an identifier of the pod.

However, the usual way of generating an IPv6 address is not representative of the functional architecture of pods. A group of pods may share common properties, which are not represented in their respective IPv6 addresses. Thus, to address a group of pods sharing common properties, each individual IPv6 address of the pods belonging to the group needs to be referenced. For example, to provide ingress or egress filtering based on IPv6 addresses for the group of pods sharing common properties, at least one filtering rule needs to be used for the IPv6 address of each pod belonging to the group. There is a scalability issue for managing such filtering rules, taking into consideration the facts that the group may contain a larger number of pods and that the pods belonging to the group may vary substantially over time.

Therefore, there is a need for a computing device and method for generating a functional IPv6 address of a pod.

### SUMMARY

According to a first aspect, the present disclosure relates to a computing device. The computing device comprises memory for storing at least one namespace, at least one associated pod type for each namespace, and an Internet Protocol version 6 (IPv6) base prefix. The computing device also comprises a processing unit, which comprises at least one processor. The processing unit selects a namespace among the at least one namespace. The processing unit selects a pod type among the at least one pod type associated to the selected namespace. The processing unit creates a pod corresponding to the selected namespace and the selected pod type. The processing unit generates a pod identifier for the pod, the pod identifier uniquely identifying the pod at the computing device level. The processing unit generates a namespace field based on the selected namespace. The processing unit generates a pod type field based on the selected pod type. The processing unit generates a functional IPv6 address of the pod by combining at least the IPv6 base prefix, the namespace field, the pod type field, and the pod identifier.

According to a second aspect, the present disclosure relates to a method for generating a functional Internet Protocol version 6 (IPv6) address of a pod. The method comprises storing in a memory of a computing device at least one namespace, at least one associated pod type for each namespace, and an IPv6 base prefix. The method comprises selecting, by a processing unit of the computing device, a namespace among the at least one namespace. The method comprises selecting by the processing unit a pod type among the at least one pod type associated to the selected namespace. The method comprises creating by the processing unit a pod corresponding to the selected namespace and the selected pod type. The method comprises generating by the processing unit a pod identifier for the pod. The pod identifier uniquely identifies the pod at the computing device level. The method comprises generating by the processing unit a namespace field based on the selected namespace. The method comprises generating by the processing unit a pod type field based on the selected pod type. The method comprises generating by the processing unit a functional IPv6 address of the pod by combining at least the IPv6 base prefix, the namespace field, the pod type field, and the pod identifier.

According to a third aspect, the present disclosure provides a non-transitory computer program product comprising instructions executable by a processing unit of a computing device. The execution of the instructions by the processing unit provides for generating a functional Internet Protocol version 6 (IPv6) address of a pod by implementing the aforementioned method.

In a particular aspect, the functional IPv6 address begins with the IPv6 base prefix, followed by the namespace field, optionally followed by a padding field, followed by the pod type field, and terminates with the pod identifier.

In another particular aspect, the processing unit further executes the pod, the execution of the pod comprising executing a containerized software application.

In still another particular aspect, the pod is a Kubernetes pod.

### BRIEF DESCRIPTION OF THE DRAWINGS

Embodiments of the disclosure will be described by way of example only with reference to the accompanying drawings, in which:

FIG. 1 represents a computing device;

FIG. 2 represents a deployment of pods on several computing devices;

FIG. 3 represents a method for generating a function IPv6 address of a pod;

FIG. 4 illustrates one of the computing devices of Figure executing a filtering software; and

FIG. 5 represents a method for filtering functional IPv6 addresses of pods.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to the generation and usage of an IPv6 address for a pod, where the IPv6 address takes into consideration the functional architecture of a pod deployment framework (e.g. Kubernetes).

### Generation of Functional Ipv6 Addresses of Pods

In the rest of the description, the Kubernetes framework will be used to describe the deployment of a pod infrastructure and the generation of functional IPv6 addresses for the pods. In Kubernetes, a pod is a containerized software application, implementing one or more software container executing on the same computing device. The present disclosure can be extended to another applicative deployment framework supporting the notion of a pod as a containerized software application, and further supporting the other functionalities of Kubernetes used for the generation of the IPv6 functional addresses (as described in the following).

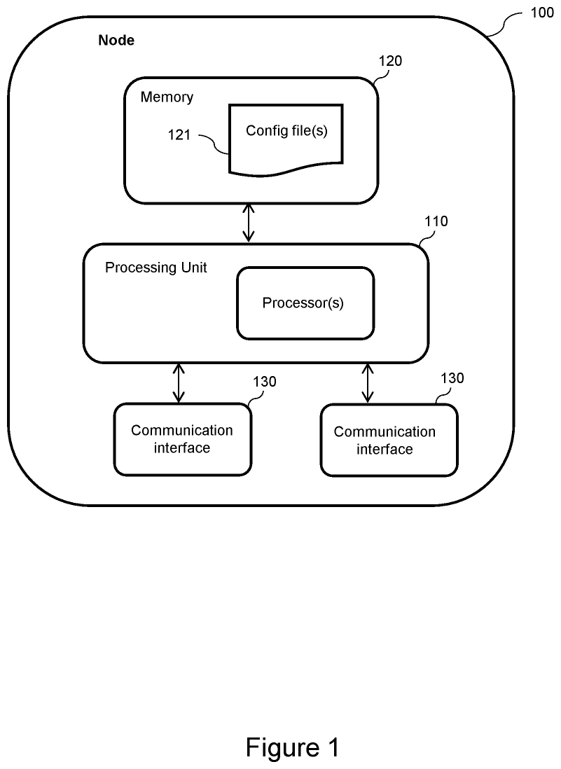

Referring now to FIG. 1, a computing device 100 is illustrated. In the rest of the description, the computing device 100 will be referred to as a node, which is the terminology generally used in the Kubernetes framework for designating a computing device executing one or more pod. Examples of nodes 100 include (without limitations) a switch, a router, a server, a desktop, a mobile computing device (e.g. smartphone or tablet), etc.

The node 100 comprises a processing unit 110, memory 120, and at least one communication interface 130. The node 100 may comprise additional components (not represented in FIG. 1 for simplification purposes). For example, the node 100 may include a user interface and/or a display.

The processing unit 110 comprises one or more processor capable of executing instructions of a computer program (a single processor is represented in FIG. 1 for illustration purposes). Each processor may further comprise one or several cores. The processing unit 110 may also include one or more dedicated processing components (e.g. a network processor, an Application Specific Integrated Circuits (ASIC), etc.) for performing specialized networking functions (e.g. packet forwarding).

The memory 120 stores instructions of computer program(s) executed by the processing unit 110, data generated by the execution of the computer program(s) by the processing unit 110, data received via the communication interface(s) 130, etc. Only a single memory 120 is represented in FIG. 1, but the node 100 may comprise several types of memories, including volatile memory (such as Random Access Memory (RAM)) and non-volatile memory (such as a hard drive, Erasable Programmable Read-Only Memory (EPROM), Electrically-Erasable Programmable Read-Only Memory (EEPROM), etc.).

Each communication interface 130 allows the node 100 to exchange data with other devices (two communication interfaces are represented in FIG. 1 for illustration purposes). Examples of communication interfaces 130 of the wireline type include standard (electrical) Ethernet ports, fiber optic ports, ports adapted for receiving Small Form-factor Pluggable (SFP) units, etc. The communication interface 130 may also be of the wireless type (e.g. a Wi-Fi interface). The communication interface 130 comprises a combination of hardware and software executed by the hardware, for implementing the communication functionalities of the communication interface 130. Alternatively, the combination of hardware and software for implementing the communication functionalities of the communication interface 130 is at least partially included in the processing unit 110.

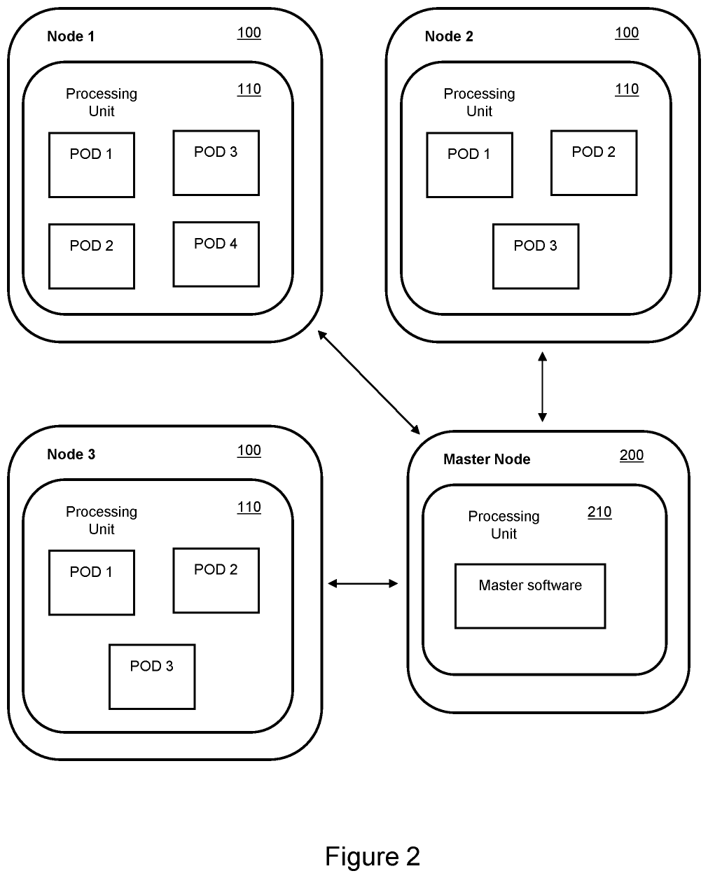

Reference is now made concurrently to FIGS. 1 and 2. FIG. 2 illustrates an architecture with three nodes 100 (respectively Node 1, Node 2 and Node 3) executing pods under the control of a master node 200. In the rest of the description, a node 100 executing pods (under the control of the master node 200) will be referred to simply as a node, by contrast to the master node.

The hardware architecture of the master node 200 is similar to the hardware architecture of the node 100 represented in FIG. 1. The master node 200 comprises a processing unit 210 executing a master software for managing (configuration, creation, execution, deletion, etc.) the pods on the nodes 100. The management of the pods by the master node 200 is based on an exchange of data between the master node 200 and the nodes 100, which is out of the scope of the presently claimed invention. Although not represented in FIG. 2 for simplification purposes, each node 100 executes a client software which interacts with the master software for implementing the management of the pods on the nodes 100.

For illustration purposes, Node 1 executes 4 pods (respectively POD 1, POD 2, POD 3 and POD 4), Node 2 executes 3 pods (respectively POD 1, POD 2 and POD 3) and Node 3 executes 3 pods (respectively POD 1, POD 2 and POD 3). Furthermore, although 3 nodes 100 have been represented in FIG. 2, any number of nodes 100 may be operating under the control of the master node 200.

The Kubernetes framework provides the functionality of namespaces, which is usually used in environments comprising a large number of user. Namespaces provide a scope for names of resources (e.g. pods, services, etc.) used in the Kubernetes framework. Names of resources are unique within a given namespace, but are not unique across namespaces.

Namespaces can be used to define resource quota limitations, which are enforced under the control of the master node 200. For example, a first namespace (corresponding to a first group of users) has a limit of 30% of the processing power and 30% of the memory provided by all the nodes 100 under the control of the master node 200, while a second namespace (corresponding to a second group of users) has a limit of 40% of the processing power and 50% of the memory provided by all the nodes 100 under the control of the master node 200. In another example, the first namespace is allocated 25% of all the nodes 100 under the control of the master node 200, while the second namespace is allocated 50% of all the nodes 100 under the control of the master node 200. Namespaces can also be used to enforce security policies, for example by reducing the privileges of a group of users belonging to a given namespace.

The Kubernetes framework also provides the functionality of pod templates. A pod template is a specification for creating pods according to the pod template. Each pod template is a text file which defines how the pods created from the pod template will behave. In particular, the pod template defines the number of software containers implemented by the pod, and for each container the particular software program(s) executed by the container. Each pod template comprises a name which identifies the pod template. In the rest of the description, the name of the pod template will be referred to as the pod type. Thus, a given pod type identifies a corresponding given pod template. Instances of pods corresponding to the given pod type will be referred to as pods of the given pod type. Several pods of the same pod type can be executed on different nodes 100 concurrently. Additionally, several pods of the same pod type can be executed on the same node 100 concurrently.

The notions of namespace and pod type are interrelated. A pod template and the associated pod type are generated in the context of a given namespace. Since the namespace and pod type consist of names, they are respectively implemented by a string, which may have a predefined length or not. For example, the namespace is a string having a maximum of N characters (e.g. 30) and the pod type is a string having a maximum of T characters (e.g. 20). The namespace strings and pod type strings may be converted to a more effective format (than strings) for internal storage and internal processing. The string format is used by users and allows the creation, modification, deletion, etc. of namespaces and pod types by the users (e.g. by an administrator using a user interface of the master node 200).

Following are exemplary namespaces and pod types corresponding to the pods represented in FIG. 2. A first namespace named “Domain A” is generated. Within the namespace “Domain A”, two pod types respectively named “app_a01” and “app_a02” are generated. Pod type “app_a01” identifies a pod template t_a01 and pod type “app_a02” identifies a pod template t_a02. POD 1 on Node 1 belongs to namespace “Domain A” and corresponds to pod type “app_a01” (POD 1 on Node 1 implements the pod template t_a01). POD 2 on Node 1 belongs to namespace “Domain A” and also corresponds to pod type “app_a01” (POD 2 on Node 1 implements the pod template t_a01). POD 1 and POD 2 illustrate two instances of the same namespace/pod type executing concurrently on the same node. POD 4 on Node 1 belongs to namespace “Domain A” and corresponds to pod type “app_a02” (POD 4 on Node 1 implements the pod template t_a02). POD 1 on Node 2 belongs to namespace “Domain A” and corresponds to pod type “app_a01” (POD 1 on Node 2 implements the pod template t_a01). POD 1 on Node 3 belongs to namespace “Domain A” and corresponds to pod type “app_a02” (POD 1 on Node 3 implements the pod template t_a02).

A second namespace named “Domain B” is generated. Within this namespace “Domain B”, two pod types respectively named “app_b01” and “app_b02” are generated. Pod type “app_b01 identifies a pod template t_b01 and pod type “app_b02” identifies a pod template t_b02. POD 3 on Node 1 belongs to namespace “Domain B” and corresponds to pod type “app_b01” (POD 3 on Node 1 implements the pod template t_b01). POD 2 on Node 2 belongs to namespace “Domain B” and corresponds to pod type “app_b02” (POD 2 on Node 2 implements the pod template t_b02). POD 3 on Node 2 belongs to namespace “Domain B” and corresponds to pod type “app_b01” (POD 3 on Node 2 implements the pod template t_b01). POD 2 on Node 3 belongs to namespace “Domain B” and corresponds to pod type “app_b02” (POD 2 on Node 3 implements the pod template t_b02).

A third namespace named “Domain C” is generated. Within this namespace “Domain C”, one pod type named “app_c01” is generated. Pod type “app_c01” identifies a pod template t_c01. POD 3 on Node 3 belongs to namespace “Domain C” and corresponds to pod type “app_c01” (POD 3 on Node 3 implements the pod template t_c01).

In a first implementation, a pod type is unique among all the defined namespaces. In a second implementation, a pod type is unique within a given namespace (the same pod type can be used in two different namespaces). In both implementations, the combination of the pod type and the namespace in which it has been defined is unique.

The number of namespaces and the number of pod types per namespace in the previous example are for illustration purposes only, and may vary with each specific implementation of a pod infrastructure. The following table summarizes the previous example.

TABLE 1

| Pod | Namespace | Pod type |
|---|---|---|
| Node 1/POD 1 | “Domain A” | “app_a01” |
| Node 1/POD 2 | “Domain A” | “app_a01” |
| Node 1/POD 3 | “Domain B” | “app_b01” |
| Node 1/POD 4 | “Domain A” | “app_a02” |
| Node 2/POD 1 | “Domain A” | “app_a01” |
| Node 2/POD 2 | “Domain B” | “app_b02” |
| Node 2/POD 3 | “Domain B” | “app_b01” |
| Node 3/POD 1 | “Domain A” | “app_a02” |
| Node 3/POD 2 | “Domain B” | “app_b02” |
| Node 3/POD 3 | “Domain C” | “app_c01” |

The Kubernetes framework further provides the functionality of allocating at least one Internet Protocol (IP) address to each pod. Thus, a pod may have an IPv4 address only, an IPv6 address only, or an IPv4 and an IPv6 address. Two pods executing on the same node 100 generally exchange data directly using their respective IP addresses. Two pods executing on two different nodes 100 exchange data using their respective IP addresses, and through the respective communication interfaces 130 of the two different nodes.

The present disclosure focuses on the generation of IPv6 addresses allocated to the pods. In the Kubernetes terminology, a cluster is a group of nodes 100 and master node(s) 200. The cluster is allocated an IPv6 prefix; for example 2001:db80:aabb/48. Each node 100 in the cluster is allocated an IPv6 prefix derived from the IPv6 prefix of the cluster; for example 2001:db80:aabb:1001/64 for Node 1, 2001:db80:aabb:1002/64 for Node 2 and 2001:db80:aabb:1003/64 for Node 3. In the rest of the description, the IPv6 prefix allocated to each node 100 will be referred to as the IPv6 base prefix.

Each pod on a given node 100 is also allocated a pod identifier of a pre-defined number of bits (e.g. 14 or 16). Within a given node 100, the pod identifiers are unique. However, the same pod identifier can be used on different nodes 100. For example, the pod identifiers 0x0001, 0x0002, 0x0003 and 0x0004 are respectively allocated to pods POD 1, POD 2, POD 3 and POD 4 on node 1. The pod identifiers 0x0001, 0x0002 and 0x0003 are respectively allocated to pods POD 1, POD 2 and POD 3 on node 2. The pod identifiers 0x0001, 0x0002 and 0x0003 are respectively allocated to pods POD 1, POD 2 and POD 3 on node 3.

The Kubernetes framework allocates a 128 bits Universal Unique Identifier (UUID) to every object of a cluster, including the pods. Thus, in an exemplary implementation, the pod identifier of a pod is generated by calculating a hash of the UUID allocated to the pod. The input of the hash function is the 128 bits UUID and the output of the hash function is the 14 (or 16) bits pod identifier. The hash function is designed so that two different values of UUID do no generate the same output when applied the hash function.

A traditional way of generating an IPv6 address for a pod is to combine the IPv6 based prefix of the node 100 on which the pod is executing with the unique identifier allocated to the pod. The following table, based on table 1, illustrates the traditional way of generating an IPv6 address for a pod.

TABLE 2

| Pod | Node IPv6 base prefix | Pod identifier | Traditional IPv6 address |
|---|---|---|---|
| Node 1/POD 1 | 2001:db80:aabb:1001/64 | 0x0001 | 2001:db80:aabb:1001::0001/128 |
| Node 1/POD 2 | 2001:db80:aabb:1001/64 | 0x0002 | 2001:db80:aabb:1001::0002/128 |
| Node 1/POD 3 | 2001:db80:aabb:1001/64 | 0x0003 | 2001:db80:aabb:1001::0003/128 |
| Node 1/POD 4 | 2001:db80:aabb:1001/64 | 0x0004 | 2001:db80:aabb:1001::0004/128 |
| Node 2/POD 1 | 2001:db80:aabb:1002/64 | 0x0001 | 2001:db80:aabb:1002::0001/128 |
| Node 2/POD 2 | 2001:db80:aabb:1002/64 | 0x0002 | 2001:db80:aabb:1002::0002/128 |
| Node 2/POD 3 | 2001:db80:aabb:1002/64 | 0x0003 | 2001:db80:aabb:1002::0003/128 |
| Node 3/POD 1 | 2001:db80:aabb:1003/64 | 0x0001 | 2001:db80:aabb:1003::0001/128 |
| Node 3/POD 2 | 2001:db80:aabb:1003/64 | 0x0002 | 2001:db80:aabb:1003::0002/128 |
| Node 3/POD 3 | 2001:db80:aabb:1003/64 | 0x0003 | 2001:db80:aabb:1003::0003/128 |

As illustrated in table 2, the IPv6 addresses allocated to the pods do not take into consideration the namespace and pod type of the pods. The present disclosure aims at providing a new method of generating the IPv6 addresses of the pods taking into consideration their respective namespace and pod type. Such IPv6 addresses will be referred to as functional IPv6 addresses.

The functional IPv6 address of a pod is generated by combining a topology component, a field based on the namespace of the pod, a field based on the pod type of the pod, and the pod identifier of the pod. In an exemplary implementation, the topology component is the IPv6 base prefix of the node on which the pod is executed.

For example, the functional IPv6 address is defined as follows: <node_prefix>: <namespace_field>: <padding_field>: <pod_type_field>: <pod_id>, where

<node_prefix> is a 64 bits field consisting of the IPv6 base prefix of the node executing the pod.

<namespace_field> is a 16 bits field generated based on the namespace of the pod.

<padding> is a 18 bits field filed with zero, which can be used for incorporating additional features to the functional IPv6 address.

<pod_type_field> is a 16 bits field generated based on the pod type of the pod.

<pod_id> is a 14 bits field consisting of the pod identifier on the node executing the pod.

A person skilled in the art will readily understand that the characteristics of one or more field can be varied. For example, the length of some of the fields can be modified, as long as the resulting functional IPv6 address has 128 bits. In another example, the order of some of the fields can be modified. In another example, the padding field can be suppressed and the length of one or more of the other fields extended.

The generation of the namespace field based on the namespace and the generation of the pod type field based on the pod type may be implemented in different ways. Since the respective lengths in terms of bits of the namespace field (e.g. 16) and the pod type field (e.g. 16) are small, a hash function can be used for this purpose. If a hash function is used, this hash function needs to generate the same result on all nodes, even if the inputs of the hash function are given in a different order. As mentioned previously, two different inputs of the hash function shall not generate the same output of the hash function. This generally requires that there is some type of central coordination of the hash function implemented by all the nodes.

For example, the string namespaces “Domain A”, “Domain B” and “Domain C” are respectively converted by a hash function in the namespace fields 0x000A, 0x000B and 0x000C. Similarly, the string pod types “app_a01”, “app_a02”, “app_a03”, “app_b01”, “app_b02” and “app_c01” are respectively converted by a hash function in the pod type fields 0x0A01, 0x0A02, 0x0A03, 0x0B01, 0x0B02 and 0x0C01.

As mentioned previously, the namespaces and pod types may also be encoded in a more effective format (than strings) by the Kubernetes framework for internal use. In the rest of the description, the reference to a namespace and a pod type may encompass any format used by Kubernetes for manipulating namespaces and pod types. If the format is compatible with the namespace field and/or the pod type field (same or lower number of bits), this format can be used directly for the namespace field and/or the pod type field. If the format is not compatible with the namespace field and/or the pod type field (larger number of bits), this format can be converted via a hash function to generate the namespace field and/or the pod type field.

The following table, based on tables 1 and 2, illustrates the exemplary generation of a functional IPv6 address for a pod. For simplification purposes, the <padding> field is set to 16 bits (instead of 18 in the previous example) and the <pod_id> field is set to 16 bits (instead of 14 in the previous example).

TABLE 3

| | Name | Pod | Pod | |
|---|---|---|---|---|
| Pod | space | type | identifier | Functional IPv6 address |
| Node 1/POD 1 | 0x000A | 0x0A01 | 0x0001 | 2001:db80:aabb:1001:000A:0000:0A01:0001 |
| Node 1/POD 2 | 0x000A | 0x0A01 | 0x0002 | 2001:db80:aabb:1001:000A:0000:0A01:0002 |
| Node 1/POD 3 | 0x000B | 0x0B01 | 0x0003 | 2001:db80:aabb:1001:000B:0000:0B01:0003 |
| Node 1/POD 4 | 0x000A | 0x0A02 | 0x0004 | 2001:db80:aabb:1001:000A:0000:0A02:0004 |
| Node 2/POD 1 | 0x000A | 0x0A01 | 0x0001 | 2001:db80:aabb:1002:000A:0000:0A01:0001 |
| Node 2/POD 2 | 0x000B | 0x0B02 | 0x0002 | 2001:db80:aabb:1002:000B:0000:0B02:0002 |
| Node 2/POD 3 | 0x000B | 0x0B01 | 0x0003 | 2001:db80:aabb:1002:000B:0000:0B01:0003 |
| Node 3/POD 1 | 0x000A | 0x0A02 | 0x0001 | 2001:db80:aabb:1003:000A:0000:0A02:0001 |
| Node 3/POD 2 | 0x000B | 0x0B02 | 0x0002 | 2001:db80:aabb:1003:000B:0000:0B02:0002 |
| Node 3/POD 3 | 0x000C | 0x0001 | 0x0003 | 2001:db80:aabb:1003:000C:0000:0C01:0003 |

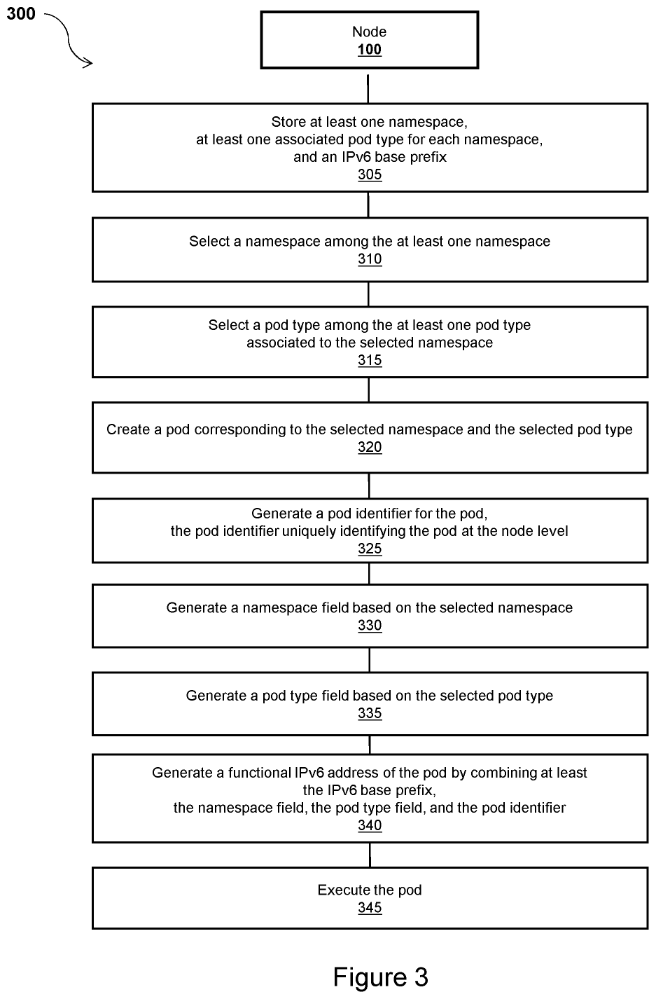

Referring now concurrently to FIGS. 1, 2 and 3, a method 300 for generating a functional IPv6 address of a pod is illustrated in FIG. 3. At least some of the steps of the method 300 are performed by each node 100 represented in FIG. 2.

A dedicated computer program has instructions for implementing at least some of the steps of the method 300. The instructions are comprised in a non-transitory computer program product (e.g. the memory 120 of the node 100). The instructions, when executed by the processing unit 110 of the node 100, provide for generating a functional IPv6 address of a pod. The instructions are deliverable to the node 100 via an electronically-readable media such as a storage media (e.g. CD-ROM, USB key, etc.), or via communication links (e.g. via a communication network through one of the communication interfaces 130 of the node 100). As mentioned previously, the processing unit 110 comprises at least one processor, each processor comprising at least one core.

The method 300 comprises the step 305 of storing at least one namespace, at least one associated pod type for each namespace, and an IPv6 base prefix in the memory 120 (e.g. in one or more configuration file 121 as illustrated in FIG. 1). Step 305 is executed by the processing unit 110 of the node 100.

For example, each namespace is defined at the master node 200 by an administrator of the cluster. For each name space, the associated one or more pod type is also defined at the master node 200 by the administrator (or a simple user) of the cluster. The one or more namespace and each corresponding one or more pod type are transmitted from the master node 200 to each node 100, received at each node 100 via the communication interface 130, and stored in the memory 120. An exemplary illustration of namespaces and corresponding pod types stored in the memory 120 of nodes Node 1, Node 2 and Node 3 has been described previously.

With respect to the IPv6 base prefix, its generation and transmission (e.g. by the master node 200 or another computing device not represented in FIG. 2) to each node 100 is out of the scope of the present disclosure. The IPv6 base prefix has a pre-defined number of bits (e.g. 64). Mechanisms for generating, managing and disseminating IPv6 prefixes among a cluster of nodes 100 are well known in the art.

The method 300 comprises the step 310 of selecting a namespace among the at least one namespace stored in the memory 120. Step 310 is executed by the processing unit 110 of the node 100.

The method 300 comprises the step 315 of selecting a pod type among the at least one pod type (stored in the memory 120) associated to the name space selected at step 310. Step 315 is executed by the processing unit 110 of the node 100. For example, if the namespace “Domain A” is selected at step 310, then one of the pod types “app_a01”, “app_a02” or “app_a03” is selected at step 315.

The method 300 comprises the step 320 of creating a pod corresponding to the namespace selected at step 310 and the pod type selected at step 315. Step 320 is executed by the processing unit 110 of the node 100. The creation of a pod, for example in the context of the Kubernetes framework, is well known in the art and is out of the scope of the present disclosure. The creation of the pod may for example include the allocation of hardware and/or software resources, the transfer of software instructions (associated to the pod type selected at step 315) from a permanent storage memory (e.g. a hard disk drive of the node 100) to a temporary execution memory (e.g. a Random-Access Memory (RAM) of the node 100), etc. The creation of the pod is based on the pod template corresponding to the selected namespace and pod type. For example, if the namespace “Domain A” is selected at step 310 and the pod type “app_a02” is selected at step 315, then the pod created at step 320 is compliant with the template t_a02.

The method 300 comprises the step 325 of generating a pod identifier for the pod created at step 320. Step 325 is executed by the processing unit 110 of the node 100. The pod identifier has a pre-defined number of bits and uniquely identifies the pod created at step 320 at the node 100 level (any two pods created on the same node 100 have respective different pod identifiers). Exemplary implementations of the determination of the pod identifier have been described previously. Step 325 may be integrated to step 320 or performed independently of step 320 (e.g. by the Kubernetes framework or by a dedicated mechanism independent of the Kubernetes framework).

The method 300 comprises the step 330 of generating a namespace field based on the namespace selected at step 310. Step 330 is executed by the processing unit 110 of the node 100. Exemplary implementations of step 330 have been described previously. The namespace field has a pre-defined number of bits.

The method 300 comprises the step 335 of generating a pod type field based on the pod type selected at step 315. Step 335 is executed by the processing unit 110 of the node 100. Exemplary implementations of step 335 have been described previously. The pod type field has a pre-defined number of bits.

The method 300 comprises the step 340 of generating a functional IPv6 address of the pod (created at step 320) by combining at least the IPv6 base prefix (stored at step 305), the namespace field (generated at step 330), the pod type field (generated at step 335), and the pod identifier (generated at step 325). Step 340 is executed by the processing unit 110 of the node 100. Exemplary implementations of step 340 have been described previously.

The method 300 comprises the step 345 of executing the pod created at step 320. Step 345 is executed by the processing unit 110 of the node 100. The execution of a pod is well known in the art, for example in the context of the Kubernetes framework. The execution of the pod comprises executing a containerized software application. The pod comprises one or more container, each container executing computer program(s). The combination of the computer program(s) executed by the container(s) implements the software application supported by the pod. The notion of containers is also well known in the art.

Although not represented in FIG. 3 for simplification purposes, the generation of the functional IPv6 address at step 340 is generally followed by an advertisement of the functional IPv6 address (performed by the processing unit 110 via the communication interface(s) 330). The advertisement may be integrated to step 345 or may be performed independently of step 345. For example, the advertisement of the functional IPv6 address is made by Node 1 to other node(s) 100 (e.g. Nodes 2 and 3), to allow communications between the pod created at step 320 on Node 1 and other pods executed on the other node(s) 100 (e.g. pods on Nodes 2 and 3), using the functional IPv6 address generated at step 340.

Following are examples of communications performed during the execution of the pod at step 345. For illustration purposes, the pod is POD 1 executed on Node 1. In a first example, the execution of POD 1 on Node 1 generates an IPv6 packet having the functional IPv6 address as a source IPv6 address, and the processing unit 110 transmits the IPv6 packet via the communication interface 130 to Node 2 (more specifically to POD 2 executed on Node 2). In a second example, an IPv6 packet having the functional IPv6 address as a destination IPv6 address is received by the processing unit 110 via the communication interface 130 (e.g. from Node 3 and more specifically from POD 3 executed on Node 3), and the IPv6 packet is processed during the execution of POD 1 on Node 1. POD 1 on Node 1 may also use the functional IPv6 address to communicate with other entities than pods. For example, POD 1 on Node 1 communicates via the functional IPv6 address with a computing device (supporting the IPv6 protocol) hosting a web server. POD 1 on Node 1 executes a web client for interacting with the web server via the functional IPv6 address.

The order of the steps performed by the method 300, as represented in FIG. 3, is for illustration purposes only. The order of some of the steps of the method 300 may be changed, without departing from the scope of the presently claimed invention. For example, steps 330 and 335 may be performed before step 320.

The selection at steps 310 and/or 315 can be performed by the processing unit 110 based on an interaction of a user of the node 100 via a user interface of the node 100. Alternatively, the selection at steps 310 and/or 315 is be performed by the processing unit 110 based on a command received via the communication interface 130 from the master node 200 (the command is based on an interaction of a user of the master node 200 via a user interface of the master node 200).

Similarly, the creation of the pod at step 320 can be performed by the processing unit 110 based on an interaction of a user of the node 100 via a user interface of the node 100. Alternatively, the creation of the pod at step 320 is performed by the processing unit 110 based on a command received via the communication interface 130 from the master node 200 (the command is based on an interaction of a user of the master node 200 via a user interface of the master node 200).

As mentioned previously, the method 300 is not limited to the Kubernetes framework, but may be extended to another framework supporting the following features: pods, namespaces and pod types (in a manner similar to the support of these features in the context of Kubernetes).

### Packet Filtering Applied to Functional Ipv6 Addresses of Pods

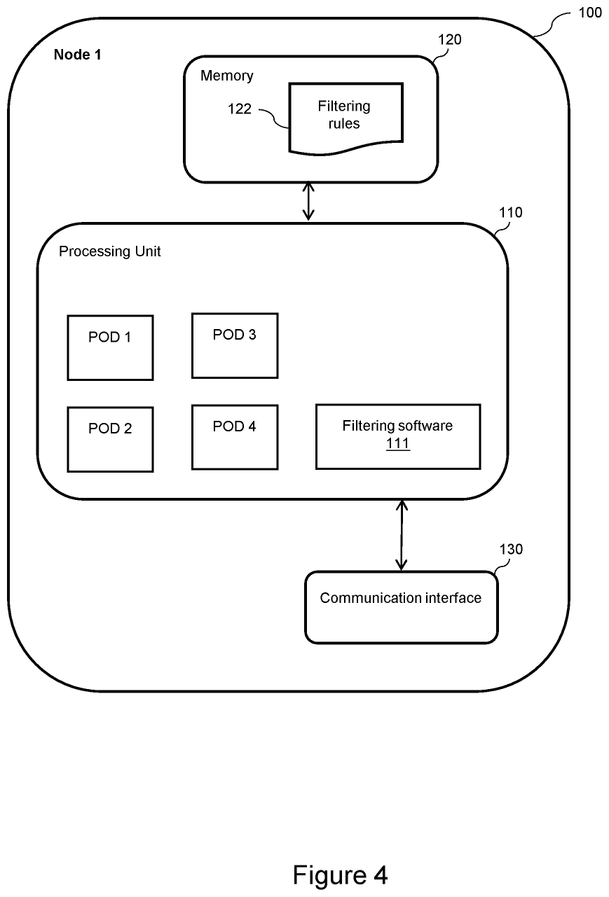

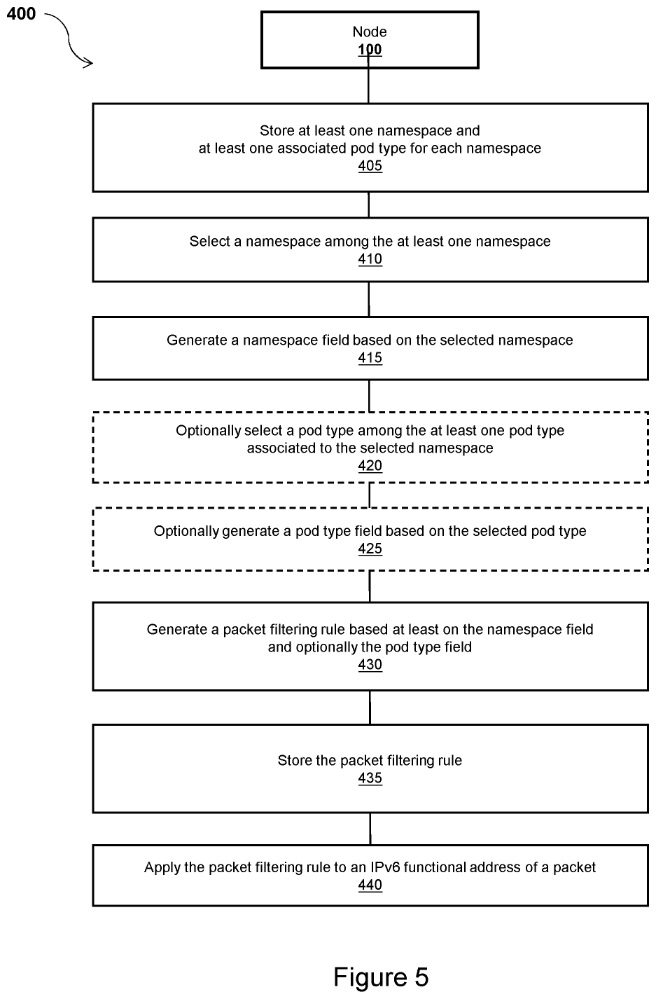

Referring now concurrently to FIGS. 4 and 5, a method 400 for performing packet filtering applied to functional IPv6 addresses of pods is illustrated in FIG. 5. At least some of the steps of the method 400 are performed by the node 100 (Node 1) represented in FIG. 4.

The node 100 (Node 1) represented in FIG. 4 corresponds to the node 100 represented in FIG. 1 and the Node 1 represented in FIG. 2. To implement the packet filtering functionality, filtering rules 122 are stored in the memory 120 and the processing unit 110 executes a filtering software 111 using the filtering rules 122 for performing packet filtering. Each filtering rule 122 includes one or more condition, and one or more corresponding action.

Packet filtering of IPv6 packets is well known in the art. Characteristics of IPv6 packets are compared to the one or more condition of the filtering rules, and if the one or more condition of a given filtering rule is satisfied, then the corresponding one or more action is executed. The characteristics of the IPv6 packets being compared include the source IPv6 address, the destination IPv6 address, the destination port (e.g. HTTP), sometimes the source port, the transport protocol (e.g. TCP, UDP), etc. The condition(s) of a filtering rule depends on the characteristic being taken into consideration. For example, whether the source IPv6 address matches a given IPv6 prefix (e.g. 2001:db80:aabb::/48), whether the destination IPv6 address does not match a given IPv6 prefix (e.g. 2001:db80:aabb:1001:164), whether the destination port or the source port matches a given port value or a given range of port values, whether the transport protocol is TCP or UDP, etc. Examples of actions include allowing or dropping the IPv6 packets matching the condition(s) of a filtering rule, modifying a field of the IPv6 packets matching the condition(s) of a filtering rule, etc. The filtering is applied to IPv6 packets received via the communication interface 130 (ingress filtering) and/or to IPv6 packets generated by the processing unit 110 to be transferred via the communication interface 130.

The previously described functional IPv6 addresses provide new filtering capabilities based on their namespace field and pod type field. New filtering rules can be created based on a selected name space alone, or based on a combination of a selected namespace and a corresponding selected pod type. Source and/or destination IPv6 addresses of IPv6 packets are parsed to identify namespace fields and pod type fields matching the selected namespace and pod type.

The method 400 provides for filtering functional IPv6 addresses of pods. At least some of the steps of the method 400 are performed by the node 100 (Node 1) represented in FIG. 4.

The method 400 comprises the step 405 of storing at least one namespace, and at least one associated pod type for each namespace, in the memory 120. Step 405 is executed by the processing unit 110 of the node 100. An exemplary implementation of step 405 has been described previously in relation to step 305 of the method 300 represented in FIG. 3.

The method 400 comprises the step 410 of selecting a namespace among the at least one namespace stored in the memory 120. Step 410 is executed by the processing unit 110 of the node 100. For example, one of the namespaces “Domain A”, “Domain B” and “Domain C” is selected at step 410. An exemplary implementation of step 410 has been described previously in relation to step 310 of the method 300 represented in FIG. 3.

The method 400 comprises the step 415 of generating a namespace field based on the namespace selected at step 410. Step 415 is executed by the processing unit 110 of the node 100. An exemplary implementations of step 415 has been described previously in relation to step 330 of the method 300 represented in FIG. 3.

The method 400 comprises the optional step 420 of selecting a pod type among the at least one pod type (stored in the memory 120) associated to the name space selected at step 410. Step 420 is executed by the processing unit 110 of the node 100. For example, if the namespace “Domain A” is selected at step 410, then one of the pod types “app_a01”, “app_a02” or “app_a03” is selected at step 420. An exemplary implementation of step 420 has been described previously in relation to step 315 of the method 300 represented in FIG. 3.

The method 400 comprises the optional step 425 of generating a pod type field based on the pod type selected at step 420 (step 425 is performed only if step 420 has been performed). Step 425 is executed by the processing unit 110 of the node 100. An exemplary implementations of step 425 has been described previously in relation to step 335 of the method 300 represented in FIG. 3.

The method 400 comprises the step 430 of generating a packet filtering rule based at least on the namespace field generated at step 415 and optionally the pod type field generated at step 425. Step 430 is executed by the processing unit 110 of the node 100. The condition of the packet filtering rule is a condition applied to the namespace field and the optional pod type field. As mentioned previously, the packet filtering rule may include additional conditions, such as a source or destination port/port range, a transport protocol, etc.

For example, namespace “Domain A” is selected at step 410 and namespace field 0x000A is generated at step 415. Steps 420 and 425 are not performed. Following is an exemplary condition of a filtering rule: namespace field of source IPv6 address of inbound IPv6 packet is equal to 0x000A. Following is another exemplary condition of a filtering rule: namespace field of destination IPv6 address of outbound IPv6 packet is different from 0x000A. Following is still another exemplary condition of a filtering rule: namespace field of destination IPv6 address of inbound IPv6 packet is equal to 0x000A. Following is yet exemplary condition of a filtering rule: namespace field of source IPv6 address of outbound IPv6 packet is different from 0x000A.

In another example, namespace “Domain B” is selected at step 410 and namespace field 0x000B is generated at step 415. Pod type “app_b02” is selected at step 420 and pod type field 0x0B02 is generated at step 425. Following is an exemplary condition of a filtering rule: namespace field of source IPv6 address of inbound IPv6 packet is equal to 0x000B and pod type field of source IPv6 address of inbound IPv6 packet is equal to 0x0B02. Following is another exemplary condition of a filtering rule: namespace field of destination IPv6 address of outbound IPv6 packet is equal to 0x000B and pod type field of destination IPv6 address of outbound IPv6 packet is different from 0x0B02. Following is still another exemplary condition of a filtering rule: namespace field of destination IPv6 address of inbound IPv6 packet is equal to 0x000B and pod type field of destination IPv6 address of inbound IPv6 packet is equal to 0x0B02. Following is yet another exemplary condition of a filtering rule: namespace field of source IPv6 address of outbound IPv6 packet is equal to 0x000B and pod type field of source IPv6 address of outbound IPv6 packet is different from 0x0B02.

As mentioned previously, one or more action is also defined for the packet filtering rule generated at step 430. For instance, a packet matching the condition(s) of the packet filtering rule may be allowed, dropped, modified, modified and allowed, etc.

The method 400 comprises the step 435 of storing the filtering rule generated at step 430 in the memory 120 (e.g. in a configuration file comprising all the filtering rules 122 used by the filtering software 111). Step 435 is executed by the processing unit 110 of the node 100.

The method 400 comprises the step 440 of applying the packet filtering rule generated at step 430 (and stored at step 435) to an IPv6 functional address of a packet. Step 440 is performed by the filtering software 111 executed by the processing unit 110 of the node 100.

As mentioned previously, the packet is an inbound packet received via the communication interface 130 or an outbound packet generated by the processing unit 110 (e.g. an outbound packet generated by POD 1). The packet filtering rule is applied to the source IPv6 address of the packet or the destination IPv6 address of the packet.

Before applying the packet filtering rule, a pre-condition may be verified: whether the packet is compliant with the functional IPv6 address format. If the packet is compliant, the packet filtering rule is applied. If the packet is not compliant, a pre-defined action is applied (e.g. drop the packet, allow the packet, etc.).

If the packet matches the condition(s) of the packet filtering rule, then the action(s) of the packet filtering rule is performed.

For example, the filtering rule consists of: namespace field of destination IPv6 address of outbound IPv6 packet is equal to 0x000B and pod type field of destination IPv6 address of outbound IPv6 packet is different from 0x0B02. The action consists in dropping an outbound IPv6 packet matching the rule.

A first outbound IPv6 packet has a destination IPv6 address with a namespace field 0x000A and any pod type field: the packet is allowed.

A second outbound IPv6 packet has a destination IPv6 address with a namespace field 0x000B and a pod type field 0x0B02: the packet is allowed.

A third outbound IPv6 packet has a destination IPv6 address with a namespace field 0x000B and a pod type field 0x0B01: the packet is dropped.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A computing device comprising:
memory for storing at least one namespace, at least one associated pod type for each namespace, and an Internet Protocol version 6 (IPv6) base prefix; and
a processing unit comprising at least one processor for:
selecting a namespace among the at least one namespace;
selecting a pod type among the at least one pod type associated to the selected namespace;
creating a pod corresponding to the selected namespace and the selected pod type;
generating a pod identifier for the pod, the pod identifier uniquely identifying the pod at the computing device level;
generating a namespace field based on the selected namespace;
generating a pod type field based on the selected pod type; and
generating a functional IPv6 address of the pod by combining at least the IPv6 base prefix, the namespace field, the pod type field, and the pod identifier.

2. The computing device of claim 1, wherein the functional IPv6 address begins with the IPv6 base prefix, followed by the namespace field, optionally followed by a padding field, followed by the pod type field, and terminates with the pod identifier.

3. The computing device of claim 1, wherein the selected namespace is a string and the processing unit generates the namespace field by calculating a hash of the selected namespace.

4. The computing device of claim 3, wherein the calculation of the hash of the selected namespace is performed by a hash function which ensures unicity of each output of the hash function.

5. The computing device of claim 1, wherein the selected pod type is a string and the processing unit generates the pod type field by calculating a hash of the selected pod type.

6. The computing device of claim 5, wherein the calculation of the hash of the selected pod type is performed by a hash function which ensures unicity of each output of the hash function.

7. The computing device of claim 1, wherein the processing unit further executes the pod, the execution of the pod comprising executing a containerized software application.

8. The computing device of claim 7, further comprising a communication interface, and wherein the execution of the pod generates an IPv6 packet having the pod IPv6 address as a source IPv6 address, and the processing unit transmits the IPv6 packet via the communication interface.

9. The computing device of claim 7, further comprising a communication interface, and wherein an IPv6 packet having the pod IPv6 address as a destination IPv6 address is received by the processing unit via the communication interface, the IPv6 packet being processed during the execution of the pod.

10. The computing device of claim 1, wherein the pod is a Kubernetes pod.

11. The computing device of claim 1, wherein the processing unit further:
selects another pod type among the at least one pod type associated to the selected namespace;
generates another pod type field based on the selected other pod type;
creates another pod corresponding to the selected namespace and the selected other pod type;
generates another pod identifier for the other pod, the other pod identifier uniquely identifying the other pod at the computing device level; and
generates a functional IPv6 address of the other pod by combining at least the IPv6 base prefix, the namespace field, the other pod type field, and the other pod identifier.

12. The computing device of claim 1, wherein the processing unit further:
selects another namespace among the at least one namespace and another pod type among the at least one pod type associated to the selected other namespace;
generates another namespace field based on the selected other namespace and another pod type field based on the selected other pod type;
creates another pod corresponding to the selected other namespace and the selected other pod type;
generates another pod identifier for the other pod, the other pod identifier uniquely identifying the other pod at the computing device level; and
generates a functional IPv6 address of the other pod by combining at least the IPv6 base prefix, the other namespace field, the other pod type field, and the other pod identifier.

13. A method for generating a functional Internet Protocol version 6 (IPv6) address of a pod, the method comprising:
storing in a memory of a computing device at least one namespace, at least one associated pod type for each namespace, and an IPv6 base prefix;
selecting by a processing unit of the computing device a namespace among the at least one namespace;
selecting by the processing unit a pod type among the at least one pod type associated to the selected namespace;
creating by the processing unit a pod corresponding to the selected namespace and the selected pod type;
generating by the processing unit a pod identifier for the pod, the pod identifier uniquely identifying the pod at the computing device level;
generating by the processing unit a namespace field based on the selected namespace;
generating by the processing unit a pod type field based on the selected pod type; and
generating by the processing unit a functional IPv6 address of the pod by combining at least the IPv6 base prefix, the namespace field, the pod type field, and the pod identifier.

14. The method of claim 13, wherein the functional IPv6 address begins with the IPv6 base prefix, followed by the namespace field, optionally followed by a padding field, followed by the pod type field, and terminates with the pod identifier.

15. The method of claim 13, wherein the selected namespace is a string and the namespace field is generated by calculating a hash of the selected namespace.

16. The method of claim 15, wherein the calculation of the hash of the selected namespace is performed by a hash function which ensures unicity of each output of the hash function.

17. The method of claim 13, wherein the selected pod type is a string and the pod type field is generated by calculating a hash of the selected pod type.

18. The method of claim 17, wherein the calculation of the hash of the selected pod type is performed by a hash function which ensures unicity of each output of the hash function.

19. The method of claim 13, further comprising executing the pod by the processing unit, the execution of the pod comprising executing a containerized software application.

20. The method of claim 19, wherein the execution of the pod generates an IPv6 packet having the pod IPv6 address as a source IPv6 address, and the processing unit transmits the IPv6 packet via a communication interface of the computing device.

21. The method of claim 19, wherein an IPv6 packet having the pod IPv6 address as a destination IPv6 address is received by the processing unit via a communication interface of the computing device, the IPv6 packet being processed during the execution of the pod.

22. The method of claim 13, wherein the pod is a Kubernetes pod.

23. The method of claim 13, further comprising:
selecting by the processing unit another pod type among the at least one pod type associated to the selected namespace;
generating by the processing unit another pod type field based on the selected other pod type;
creating by the processing unit another pod corresponding to the selected namespace and the selected other pod type;
generates another pod identifier for the other pod, the other pod identifier uniquely identifying the other pod at the computing device level; and
generating by the processing unit a functional IPv6 address of the other pod by combining at least the IPv6 base prefix, the namespace field, the other pod type field, and the other pod identifier.

24. The method of claim 13, further comprising:
selecting by the processing unit another namespace among the at least one namespace and another pod type among the at least one pod type associated to the selected other namespace;
generating by the processing unit another namespace field based on the selected other namespace and another pod type field based on the selected other pod type;
creating by the processing unit another pod corresponding to the selected other namespace and the selected other pod type;
generating by the processing unit another pod identifier for the other pod, the other pod identifier uniquely identifying the other pod at the computing device level;
generating by the processing unit a functional IPv6 address of the other pod by combining at least the IPv6 base prefix, the other namespace field, the other pod type field, and the other pod identifier.

25. A non-transitory computer program product comprising instructions executable by a processing unit of a computing device, the execution of the instructions by the processing unit providing for generating a functional Internet Protocol version 6 (IPv6) address of a pod by:
storing in a memory of the computing device at least one namespace, at least one associated pod type for each namespace, and an IPv6 base prefix;
selecting by the processing unit a namespace among the at least one namespace;
selecting by the processing unit a pod type among the at least one pod type associated to the selected namespace;
creating by the processing unit a pod corresponding to the selected namespace and the selected pod type;
generating by the processing unit a pod identifier for the pod, the pod identifier uniquely identifying the pod at the computing device level;
generating by the processing unit a namespace field based on the selected namespace;
generating by the processing unit a pod type field based on the selected pod type;
generating by the processing unit a functional IPv6 address of the pod by combining at least the IPv6 base prefix, the namespace field, the pod type field, and the pod identifier; and
executing by the processing unit the pod, the execution of the pod comprising executing a containerized software application.

26. The computer program product of claim 25, wherein the functional IPv6 address begins with the IPv6 base prefix, followed by the namespace field, optionally followed by a padding field, followed by the pod type field, and terminates with the pod identifier.
